(19) United States
(12) Patent Application Publication
(10) Pub. No.: US 2010/0083084 A1
(43) Pub. Date: Apr. 1, 2010

(54) CREATING ELECTRONIC DATA INTERCHANGE RELATIONSHIPS

(76) Inventors: Joseph Stephan Cicman, Columbus, OH (US); Rama Subba Reddy Sathi, Dublin, OH (US)

Correspondence Address: AT&T Legal Department - JW;Attn: Patent Docketing, Room 2A-207, One AT&T Way, Bedminster, NJ, 07921, US

(21) Appl. No.: 12/415,709

(22) Filed: Mar. 31, 2009

Related U.S. Application Data
(60) Provisional application No. 61/101,068, filed on Sep. 29, 2008.

(51) Int. Cl. G06F 17/00; G06F 17/30

(52) U.S. Cl. 715/212; 715/234; 707/E17.044

(57) ABSTRACT

Disclosed services, methods, systems, networks, and software media for facilitating the creation of data structures to enable a pair of enterprises to exchange documents such as business documents may enable a user to specify values for a set of parameters associated with an exchange of a business document between an entity and a trading partner and enable a user to invoke an envelope creation utility (ECU). When the user invokes the ECU, the specified set of parameter values and a set of one or more predefined business processes are accessed to create set of electronic document envelopes suitable for electronic transmission of a business document.

This application claims priority to provisional patent application Ser. No. 61/101,068 filed Sep. 29, 2008, which is incorporated in its entirety by reference herein.

### REFERENCE TO COMPUTER PROGRAM LISTING APPENDIX

A computer program listing appendix is electronically submitted with this application.

### BACKGROUND

1. Field of the Disclosure

The present disclosure relates to electronic business transactions and, more specifically, tools for facilitating EDI implementations.

2. Description of Related Art

Electronic Data Interchange (EDI) refers to electronic transmission of strictly formatted messages, representing business documents, between enterprises. EDI contemplates a sequence of messages between two enterprises, either of whom may serve as originator or recipient. The formatted data representing the business documents may be transmitted from originator to recipient via a communication network. An EDI exchange is generally intended to be a machine-driven exchange. Human intervention in the processing of a received message may be reserved for special situations such as when error conditions occur or when quality review is desired. Despite the pervasiveness of technologies such as extensible markup language (XML) web services, the Internet, and the World Wide Web, EDI remains as the data format used for a vast majority of electronic commerce transactions.

In EDI, information is organized according to a specified format set by both parties, allowing a “hands off” transaction that requires no human intervention or rekeying by either party. The information contained in an EDI transaction set is, for the most part, the same as on a conventionally printed document. EDI may be described as a technical representation of a business conversation between two enterprises or between two entities within a single enterprise. EDI may be thought of as encompassing, in addition to rigorously standardized document formats, the entire business document exchange paradigm, including, for example, the transmission, message flow, and software used to interpret the documents.

EDI standards are independent of communication and software technologies. EDI can be transmitted using any methodology agreed to by the sender and recipient. This includes a variety of technologies, including asynchronous and bisynchronous modems, file transfer protocol (FTP), Email, hypertext transfer protocol (HTTP), Applicability Statement 1 (AS1), Applicability Statement 2 (AS2), etc. As more EDI trading partners use the Internet for transmission, standards have emerged. The Internet Engineering Task Force (IETF) Request for Comment (RFC) 3335, describes the transfer of EDI data via e-mail. IETF RFC 4130 describes multi-purpose Internet mail extensions (MIME)-based HTTP EDIINT transfers, sometimes referred to as AS2 transfers. The IETF is preparing similar documents for FTP transfers (AS3). While some EDI transmission has moved to these newer protocols, the providers of the value-added networks remain active.

EDI documents generally contain the same information that would normally be found in a paper document used for the same organizational function. For example an EDI 940 ship-from-warehouse order is used by a manufacturer to tell a warehouse to ship product to a retailer. It typically has a “ship to” address, “bill to” address, a list of product numbers (usually UPC codes) and quantities. It may have other information if the parties agree to include it.

Although the implementations and embodiments described herein emphasize EDI as a tool for the exchange of commerce documents, EDI is not limited to trade-based business data and encompasses fields including medicine (e.g., patient records and laboratory results), engineering and construction, etc. In some cases, EDI will be used to create a new business information flow (that was not a paper flow before). This is the case in the Advanced Shipment Notification (856) which was designed to inform the receiver of a shipment, the goods to be received and how the goods are packaged.

Among the various EDI standards, UN/EDIFACT is predominant outside of North America while American National Standards Institute (ANSI) Accredited Standards Committee (ASC) X12 (X12) is predominant in North America. The standards prescribe the formats, character sets, and data elements used in the exchange of business documents and forms. The complete EDI Document List includes all major business documents, including purchase orders (called “ORDERS” in UN/EDIFACT and an “850” in X12) and invoices (called “INVOIC” in UN/EDIFACT and an “810” in X12).

EDI standards specify the information that is mandatory for a particular document and the information that is optional. EDI standards also define rules governing document structure. EDI standards have been analogized to building codes. Two kitchens built “to code” may look completely different. By analogy, two EDI standard compliant documents can contain different sets of information. A food company may, for example, indicate a product's expiration date while a clothing company may indicate a product's color and size.

### BRIEF DESCRIPTION OF THE DRAWINGS

FIG. 1 depicts selected aspects of an embodiment of a electronic business environment including an integration suite;

FIG. 2 depicts selected aspects of an embodiment of an integration suite such as the integration suite of FIG. 1;

FIG. 3 illustrates aspects of an implementation of an envelope for use in an electronic document exchange application;

FIG. 4 is a flow diagram of selected aspects of a method for provisioning an EDI relationship including the creation of document exchange envelopes such as the envelope depicted in FIG. 3;

FIG. 5 is a flow diagram of selected aspects of a method for automatically generating EDI compliant envelopes for an EDI relationship;

FIG. 6 is a flow diagram of selected aspects of a method for migrating a legacy EDI application to a current application; and

FIG. 7 is a block diagram of selected aspects of a data processing system.

### DESCRIPTION OF THE EMBODIMENT(S)

In one aspect, disclosed services, methods, systems, networks, and software media facilitate the creation of data structures to enable a pair of enterprises to exchange documents such as business documents. A user is enabled to specify values for a set of parameters associated with an exchange of a business document between an entity and a trading partner. The user is further enabled to invoke an envelope creation utility (ECU). When the user invokes the ECU, the specified set of parameter values and a set of one or more predefined business processes are accessed to create a set of electronic document envelopes suitable for electronic transmission of a business document. Embodiments may be implemented as computer executable instructions stored in a tangible computer readable storage medium.

The service may encompass a migration implementation in which the user invokes a migration tool and specifies the results of the migration tool as the input to the ECU. The user may be enabled to specify the applicable parameter values by including the values in a spreadsheet that is accessed by the ECU. The electronic transmission may encompass electronic transmission that is compliant with an EDI standard such as ANSI X12. The set of parameters that the ECU accesses to create the envelopes may include EDI Standard, Interchange Sender Qualifier, Interchange SenderID, Interchange Receiver Qualifier, Interchange ReceiverID, Group SenderID, Group ReceiverID, Interchange Version, Group Version, Transaction Set/Message Type, Extraction Directory, Extracted FileName, Map Name, Test/Production, Direction, TradingPartner Name, Generate Acknowledgement?, Element Separator, Release Character, Segment Terminator, SubElement Separator, Send TO (Outbound Extraction Directory), Acceptor Lookup Alias, Application Sender ID, or Application Receiver ID.

In another aspect, a service and method for facilitating the provisioning of an electronic document exchange relationship between a pair of entities includes providing a template for specifying values for a set of document exchange parameters and for storing the values. A user is then enabled to specify a start time for an ECU of an EDI application. The EDI application launches the ECU when the start time arrives. The ECU is configured to retrieve the specified values and generate an EDI compliant envelope data structure based on the specified values.

In some embodiments, the method includes configuring the ECU to generate the EDI compliant envelope by providing an envelope creation style sheet. A utility may be provided to populate the template based on an envelope definition generated by a legacy application. The envelope definition may include an XML file. The EDI compliant envelope may be an ASC X12 compliant envelope, an EDIFACT compliant envelope, an ODETTE compliant envelope, and a TRADACOMS envelope.

The document exchange parameters that may be employed to generate the EDI envelopes include parameters selected from the list of parameters consisting of: EDI Standard, Interchange Sender Qualifier, Interchange SenderID, Interchange Receiver Qualifier, Interchange ReceiverID, Group SenderID, Group ReceiverID, Interchange Version, Group Version, Transaction Set/Message Type, Extraction Directory, Extracted FileName, Map Name, Test/Production, Direction, TradingPartner Name, Generate Acknowledgement?, Element Separator, Release Character, Segment Terminator, SubElement Separator, Send TO (Outbound Extraction Directory), Acceptor Lookup Alias, Application Sender ID, and Application Receiver ID.

The spreadsheet may be derived from a template. Providing the template may include providing a template suitable for use with a spreadsheet application operable to storage the values as a comma separated value (CSV) or another type of delimited text file.

In another aspect, a disclosed data processing system includes a processor and computer readable storage accessible to the processor. The storage includes computer executable instructions for automatically generating an XML file suitable for defining an EDI document envelope from a delimited text file containing values for a small set of envelope creation parameters. In some embodiments, for example, the number of envelope creation parameters is N or fewer, where N is 25. The system may further include instructions for automatically populating the delimited text file with the values based on an EDI document envelope from a legacy EDI application, e.g., Gentran:Windows from Sterling Commerce/AT&T.

Disclosed herein is an ECU for provisioning EDI relationships within an EDI application, and for more completely migrating EDI relationships from legacy systems. The disclosed tool may perform one or more functions including 1) in a batch fashion, provisioning partner EDI relationships in the EDI application software package, and 2) enriching the provisioning data from a migration utility of the EDI application (from partner profile records in a legacy application) and normalizing it into the batch provisioning format. In embodiments developed for the Gentran Integration Suite (GIS), the ECU may leverage features of GIS including data transformation capabilities, XSLT style sheets, Excel spreadsheet template, and winconvert.sh and convert.sh programs which ship with GIS.

The disclosed ECU assumes a set of applicable business processes are defined within GIS. The ECU as disclosed provisions trading relationships using objects associated with the existing business models. Since the objects are known, the tool can default to using those object names in the provisioning records. The disclosed ECU eliminates the need to traverse the 2-3 dozen screens per relationship. The disclosed ECU enables the user to identify values for a limited set of parameters, for example, by listing the parameter values in a spreadsheet. The spreadsheet serves as a replacement for the user's existing spreadsheet of relationships. With typical EDI systems containing sometimes hundreds of partner relationships, each time the tool is used (in a system migration), it can save up to 50 hours of consultant effort.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

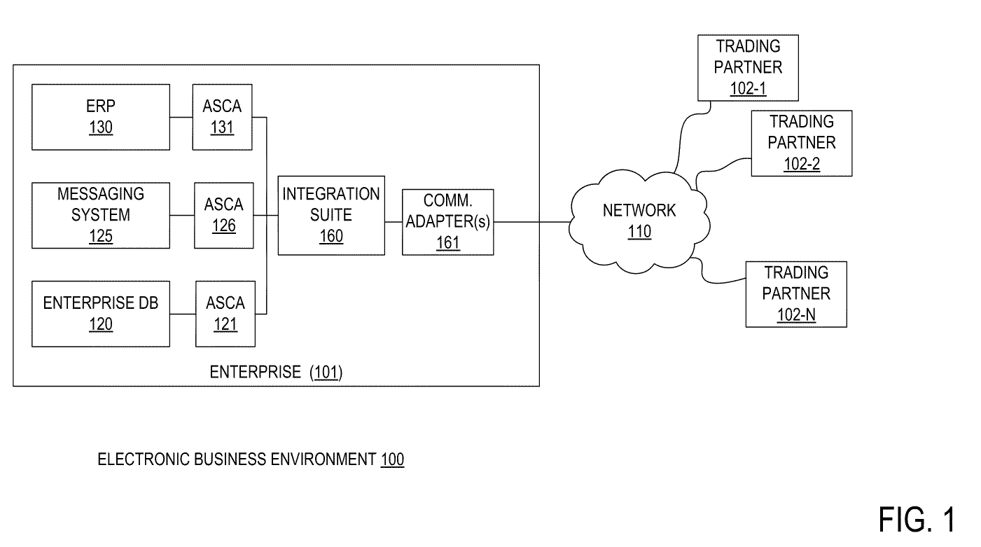

Referring to FIG. 1, selected aspects of an embodiment of an electronic business (eBusiness) environment 100 are depicted. In the depicted embodiment, eBusiness environment 100 is suitable for performing electronic, business-to-business transactions including the electronic exchange of business documents using EDI or another suitable standard. In the embodiment depicted in FIG. 1, eBusiness environment 100 encompasses an enterprise 101, a network 110, and a set of N trading partners 102, three of which are depicted in FIG. 1 as trading partners 102-1, 102-2, and 102-N.

In the depicted embodiment, eBusiness environment 100 includes or encompasses the use of network 110. Network 110 may be an Internet protocol (IP) network and may include elements of a public network such as the Internet, elements of a private network such as a corporate intranet, a private local area network, or another private network, or a combination thereof Network 110 may include routers, gateways, repeaters, and other network resources not depicted in FIG. 1.

Enterprise 101 as depicted in FIG. 1 is represented by software and/or hardware resources supporting eBusiness transactions. Enterprise 101 as shown includes an enterprise database management system (DBMS) 120, a messaging system 125, and an enterprise resource planning (ERP) application, referred to herein simply as ERP 130, in communication with trading partners 102 through an integration suite 160. ERP 130 is an enterprise-wide information system that coordinates the resources, information, and activities needed to complete business processes such as order fulfillment or billing. ERP 130 supports most of the business systems that maintain, in DBMS 120, the data needed for a variety of business functions including, as examples, manufacturing, supply chain management, financials, projects, human resources and customer relationship management. ERP 130 may include elements of commercially distributed ERP solutions including, as an example, the SAP ERP product, formerly known as systems application and products (SAP) R/3, from SAP AG.

In the depicted embodiment, ERP 130 operates in conjunction with messaging system 125 and DBMS 120. Messaging system 125 is a message oriented middleware application. Messaging system 125 enables independent and potentially non-concurrent applications on a distributed system to communicate with each other. The messaging system 125 may include elements of an exemplary messaging application such as the WebSphere® MQ product from IBM. The DBMS 120 may be implemented as a relational database management system (RDBMS) and may include elements of commercially distributed RDBMS applications including the Oracle Database RDBMS from Oracle or DB2 from IBM.

As depicted in FIG. 1, DBMS 120, messaging system 125, and ERP 130 communicate with integration suite 160 through a respective set of application specific communication adapters (ASCAs) including ASCAs 121, 126, and 131. Similarly, integration suite 160 communicates with network 110 and trading partners 102 through a communication adapter 161. Whereas messaging system 125 is configured to facilitate integration of potentially incompatible resources within enterprise 101, integration suite 160 is configured to facilitate communication among these subsystems of enterprise 101 and a set of one or more trading partners 102. The integration suite 160 may, for example, include resources to facilitate the exchange of business documents using a defined standard for document exchange including, as an example, EDI. Although other embodiments may use a different standard than EDI, EDI implementations are emphasized herein for the sake of clarity.

Trading partners 102 depicted in FIG. 1 may represent commercial entities that engage in buying, selling, or other forms of commercial transactions with enterprise 101. As such, partners 102 may include customer partners, i.e., entities that primarily buy goods or services from enterprise 101, as well as supplier partners, i.e., entities that primarily sell goods or services. Although trading partners 102 may include elements analogous to the elements shown with respect to enterprise 101, any such elements are omitted from FIG. 1 for the sake of clarity.

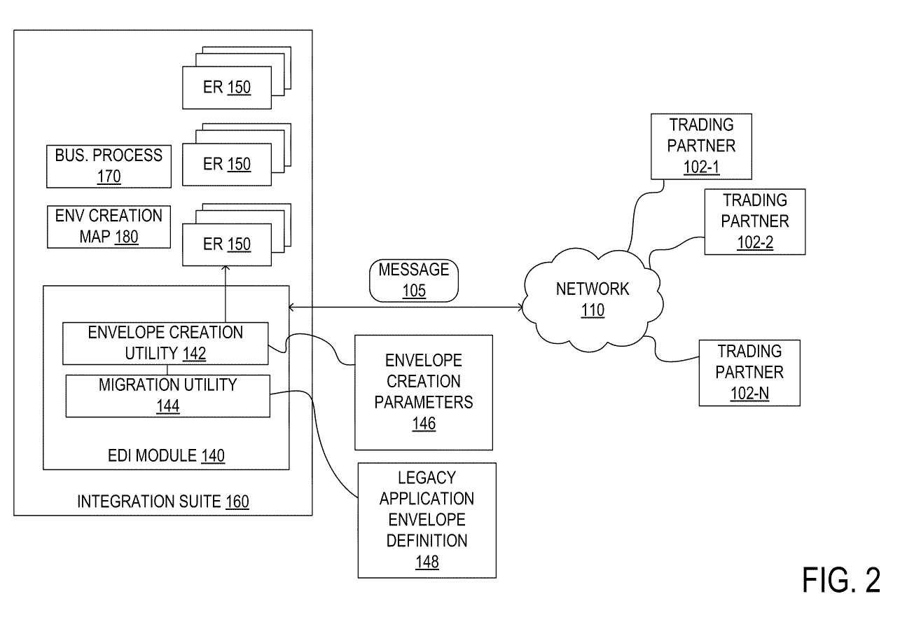

For enterprises engaged in EDI, EDI implies the creation of EDI relationships, where an EDI relationship defines a structure and format for an EDI message exchanged between two enterprises. Referring to FIG. 2, additional detail of selected elements of integration suite 160 are depicted. In the depicted embodiment, integration suite 160 exchanges business documents in the form of one or more EDI messages 105 with trading partners 102-1, 102-2, and 102-N via network 110 and a communication adapter 161 that is omitted from FIG. 2 for the sake of clarity. Messages 105 may include business documents such as purchase orders, invoices, shipping notifications, and so forth. Integration suite 160 may include elements of enterprise integration applications such as the GIS from Sterling Commerce, an AT&T company (hereinafter “Sterling Commerce”).

The depicted embodiment of integration suite 160 includes an EDI module 140. As its name suggests, EDI module 140 is operable to facilitate the exchange of EDI documents on behalf of integration suite 160. In some embodiments, EDI module 140 includes an ECU 142 that facilitates the generation of EDI relationship envelopes (ER) 150 needed to exchange business documents with trading partners 102. EDI module 140 may further include a migration utility 144 that facilitates the creation of EDI envelopes for EDI module 140 from EDI envelope definitions defined in legacy applications or including, as an example, Gentran:Windows from Sterling Commerce. FIG. 2 depicts a legacy application envelope definition 148. Legacy application envelope definition 148 may represent an EDI envelope defined in or created by a legacy application including, as an example, Gentran:Windows.

In some embodiments, ECU 142 is designed to operate on a limited set of data in conjunction with a defined set of one or more business processes 170. In the depicted embodiment, for example, ECU 142 accesses values for a set approximately of 25 or fewer envelope creation parameters 146. The values for envelope creation parameters 146 may be stored in a conventional spreadsheet, e.g., an Excel® spreadsheet format. As retrieved and employed by ECU 142, envelope creation parameters 146 may be stored as a text delimited file. ECU 142 may access envelope creation parameters 146 and business process 170 and the objects defined for those processes to generate a set of ER envelopes 150 that enable enterprise 101 to exchange documents with a trading partner 102.

If the user specifies values for some or all of the envelope creation parameters 146 indicated in the spreadsheet, ECU 142 is operable to access parameter 146 and generate a set of ER envelopes 150 that are suitable for exchanging documents with an applicable trading parameter 102. In some embodiments, ECU 142 employs mapping functionality of the EDI application, in conjunction with an envelope creation map 180, to facilitate the creation of ER envelopes 150. XML coding for an exemplary envelope creation style sheet 180 is included in a Software Listing Appendix submitted herewith. Envelope creation style sheet 180 may be an XML Style Sheet Language (XSLT) style sheet.

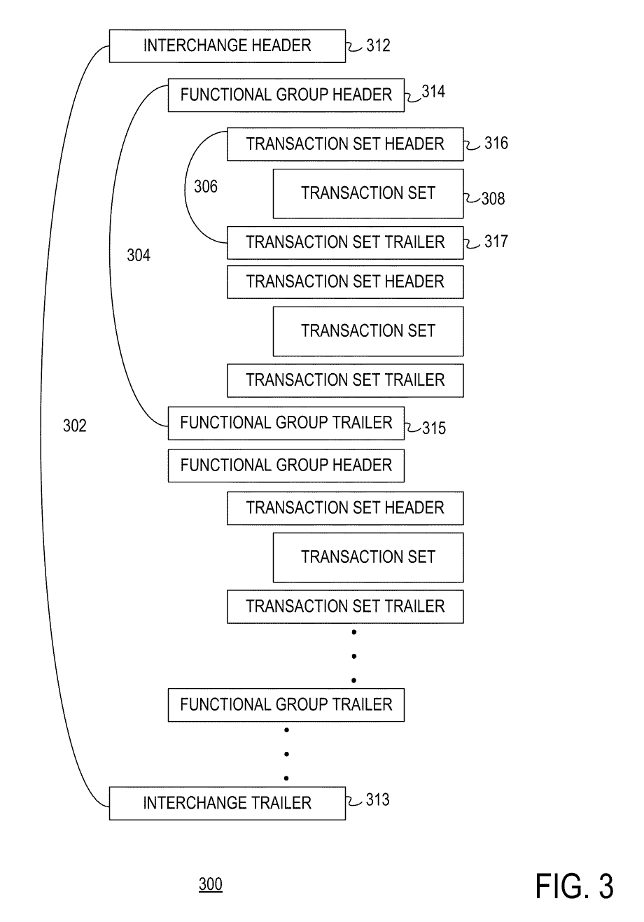

Referring to FIG. 3 selected aspects of a document envelope definition 300, also more simply referred to herein as envelope 300, are depicted. Envelope 300 may comply with a standard such as any of the various EDI standards. Envelope 300 provides a structure and consistency for exchanging pertinent information. Envelope 300 may include control information that enables organizations to effectively exchange documents. This control information may be added in headers and trailers to documents.

Document envelope 300 is specific to the EDI protocol used. GIS supports the use of CII, TRADACOMS, ACH-CTX, EDIFACT, ODETTE, and ASC X12 protocols. Of these, CII, TRADACOMS, and ACH-CTX have only one level of envelopes the message group header. The remaining protocols each have three layers of enveloping.

An interchange envelope 302 is the outermost envelope of data. Interchange envelope 302 contains an interchange header 312, an interchange trailer 313, and all the data sent from one sender to one receiver in the same transmission.

The second layer of enveloping in EDIFACT or ASC X12 is the functional group envelope layer 304. Each functional group envelope layer 304 contains a functional group header 314 and a functional group trailer 315 that surround a group of transaction sets of the same type. The third set of enveloping is transaction set layering. The transaction set envelope layer 306 includes a transaction set header 316, a transaction set trailer 317, and contains a transaction set 308.

Envelopes 300 may specify whether an exchanged document is inbound or outbound. Inbound envelopes may identify documents that come into integration suite 160 so that they can be properly routed. Inbound envelopes may translate documents and/or check documents for compliance. By choosing to translate documents from within the envelope, a user can reduce document processing time because the user does not need to specify a separate translation service step in the business process.

Outbound envelopes identify documents so that they can be sent to and received by trading partners. Generated envelopes may require modification from time to time for one or more of the following reasons: to change to a version of the standard that integration suite 160 supports, to specify a business process or contract to use with an envelope, to specify a map to use with an envelope, and to specify an AcceptorLookupAlias key to use with the EDI Encoder service.

The use of document envelopes such as envelopes 300 includes creating document translation maps to translate the documents being enveloped. Maps should be created in the proper level order (where applicable), i.e., interchange envelope layer 302 first, functional group envelope 304 second, and transaction set 306 third.

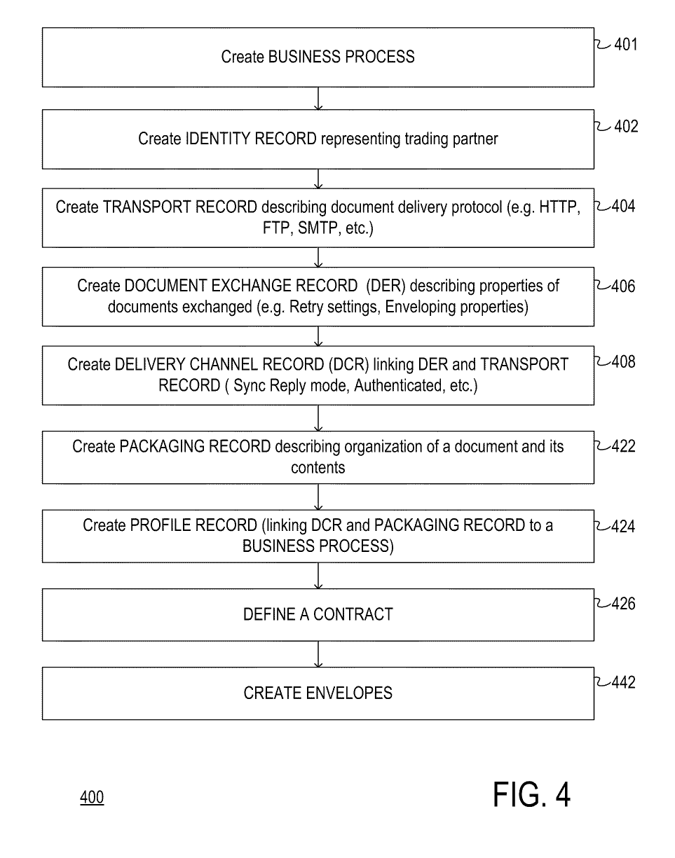

In some embodiments, the disclosed ECU 142 represents a utility offered in conjunction with an implementation of GIS. In these embodiments, a process for creating EDI compliant document envelopes suitable for exchanging EDI compliant documents with a trading partner is depicted in FIG. 4. In the depicted embodiment, process 400 includes creating (401) a business process, and creating various GIS records including an IDENTITY RECORD (block 402) that represents a trading partner, a TRANSPORT RECORD (block 404) describing document delivery protocols, e.g., HTTP, FTP, simple mail transfer protocol (SMTP), etc., a DOCUMENT EXCHANGE RECORD (DER) (block 406) describing properties of documents exchanged (e.g. Retry settings, Enveloping properties), and a DELIVERY CHANNEL RECORD (DCR) (block 408) linking DER and TRANSPORT RECORD (Sync Reply mode, Authenticated, etc.).

The depicted embodiment of process 400 may further include creating (block 422) a PACKAGING RECORD describing an organization of a document and its contents and creating a PROFILE RECORD (block 424) linking the DCR and the PACKAGING RECORD to a predefined BUSINESS PROCESS. A GIS contract may then be defined (block 426). With the contract and all other GIS records in place and the applicable business process or processes defined, the depicted embodiment of FIG. 3 includes creating (block 442) a set of envelopes.

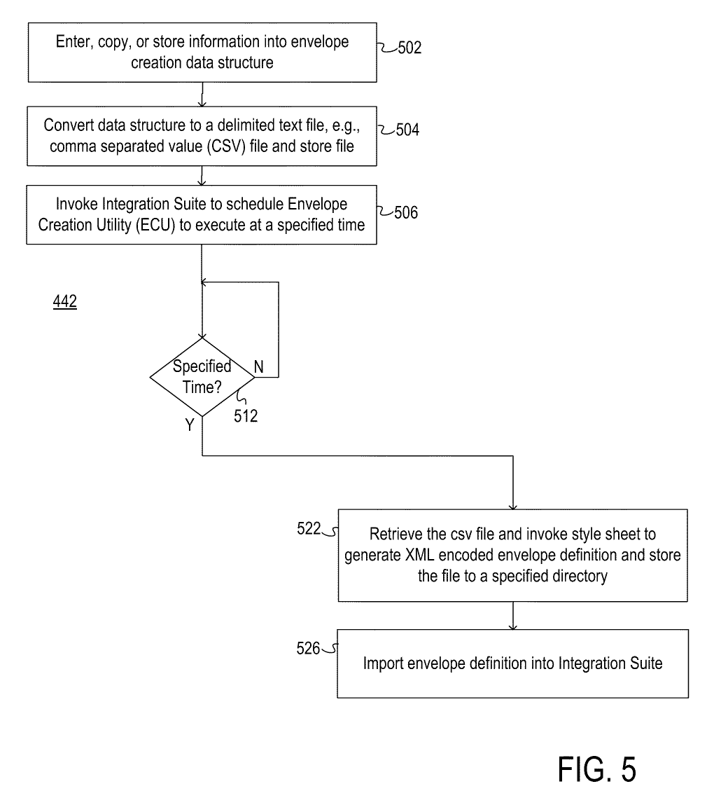

Referring to FIG. 5, an exemplary embodiment of block 442 of FIG. 4 is provided. The embodiment depicted in FIG. 5 facilitates the automated creation of EDI compliant envelopes for exchanging business documents. In the depicted embodiment, method 442 includes entering, copying, or otherwise storing (block 502) document exchange information into an envelope creation data structure. The envelope creation data structure might be a format compatible with a conventional spreadsheet application such as the Excel® program from Microsoft.

The envelope creating data structure is then converted (block 504) or otherwise stored as a delimited text file. The delimited text file may be a CSV file or another type of delimited text file. As depicted in FIG. 5, method 442 further includes a user invoking GIS to specify (block 506) a start time representing a time when the ECU or another batch conversion application executes. When the specified start time arrives (block 512) the ECU application will retrieve (block 522) and initiate a translation process. In some embodiments, the translation process is performed by calling a XSLT style sheet to extract the enveloped configuration data in the CSV file to provision a set of multiple envelopes. After the translation is completed, method 442 as shown further includes importing (block 526) the translated envelope documents into an appropriate folder of GIS for subsequent use by the EDI application.

The depicted embodiment of method 442 includes an initial block 502 in which the envelope configuration data is entered. The entry envelope configuration data may be manual in some embodiments. In other embodiments, the entry of information into the envelope creation data structure occurs in an automated fashion using envelope definitions from legacy applications including legacy integration suite applications such as Gentran:Windows.

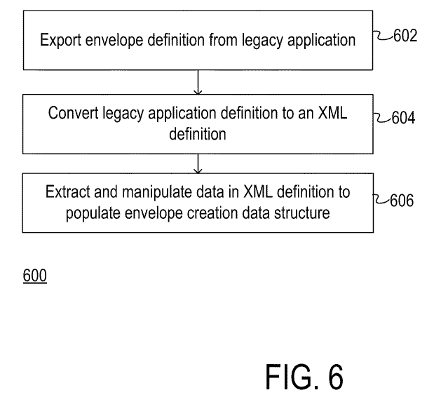

Turning to FIG. 6, selected elements of a method 600 for migrating envelope definitions to integration suite 160 are depicted. In the depicted embodiment, method 600 includes exporting (block 602) an envelope definition from a legacy application and converting (block 604) the legacy application definition to an XML formatted definition. The envelope definition data may then be extracted and manipulated (block 606) to populate the envelope creation data structure.

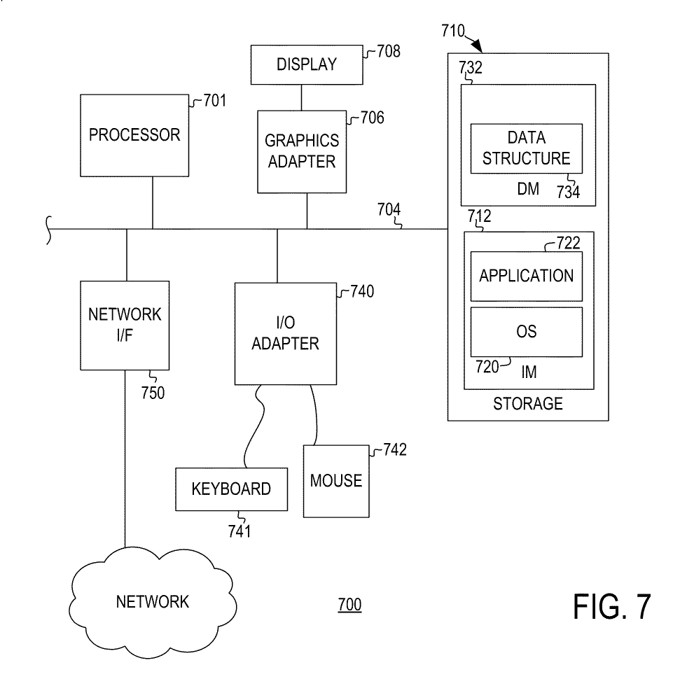

Referring now to FIG. 7, a block diagram of selected elements of a data processing system 700 is presented. Data processing system 700 as depicted in FIG. 7 is an exemplary general purpose data processing system that encompasses the data processing systems depicted in FIG. 1 including, as an example, Enterprise DBMS 120. In the depicted embodiment, data processing system 700 includes a processor 701 and a computer readable storage 710 accessible to processor 701 via a bus 704.

Storage 710 encompasses various types of computer memory media including volatile memory such as dynamic and static random access memory, persistent memory including magnetic drives, solid state drives, flash memory, read only memories including programmable and/or erasable read only memories, optical storage media such as compact discs and digital versatile discs, magnetic tape media and so forth. Storage 710 is operable to store programs, i.e., computer executable instructions, and data and data processing system 700 as depicted in FIG. 7 includes an instruction memory 712 and a data memory 732. Although FIG. 7 distinguishes between instruction memory 712 and data memory 732, this distinction may be an organizational distinction only and may or may not reflect a distinction in terms of any physical, logical, or virtual architecture. Instruction memory 712 as shown includes an operating system 720 and an application 722 while data memory 732 is shown as including a data structure 734. Application 722 may represent substantially any application executable by data processing system 700 including, for example, EDI Module 140 of FIG. 2.

Data processing system 700 as shown in FIG. 7 further includes a graphics adapter 706, a network interface 750 and an I/O adapter 740 all connected to bus 704. Graphics adapter 706 controls a display 708 to provide visual output in the form of computer graphics including graphical user interfaces, still video images, video streams, and so forth. Network interface 750 is operable to connect data processing system 700 and processor 701 to an external network including any IP based network such as the Internet, a corporate intranet, an Ethernet-based local area network, and so forth. I/O adapter 740 interfaces with an input device 742 including a keyboard 741, a pointing device, and so forth.

In the case of migration from a legacy application, some embodiments of EDI Module 140 include migration capability that may extract or otherwise identify information needed to populate legacy application envelope definition 148. The user may then “cut and paste” the information generated by the migration utility into spreadsheet 148 and execute the ECU 142 as described to create the ER envelopes 150.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A service for facilitating a provisioning of an electronic document exchange relationship between a pair of entities, comprising:
providing a template for specifying values for a set of document exchange parameters and for storing the values;
enabling a user to specify a start time for an envelope creation utility (ECU) of an electronic data interchange (EDI) application;
configuring the EDI application to launch the ECU in response to arrival of the start time; and
configuring the ECU to retrieve the specified values and generate an EDI compliant envelope data structure based on the specified values.

2. The service of claim 1, wherein configuring the ECU to generate the EDI compliant envelope comprises providing an envelope creation style sheet.

3. The service of claim 1, further comprising:
providing a utility to populate the template based on an envelope definition generated by a legacy application.

4. The service of claim 3, wherein the envelope definition comprises an extensible markup language (XML) file.

5. The service of claim 1, wherein the EDI compliant envelope is an accredited Standards Committee (ASC) X12 compliant envelope.

6. The service of claim 1, wherein the EDI compliant envelope is compliant with a standard selected from the group consisting of EDIFACT, ODETTE, and TRADACOMS.

7. The service of claim 1, wherein the document exchange parameters include parameters selected from the list of parameters consisting of: EDI Standard, Interchange Sender Qualifier, Interchange SenderID, Interchange Receiver Qualifier, Interchange ReceiverID, Group SenderID, Group ReceiverID, Interchange Version, Group Version, Transaction Set/Message Type, Extraction Directory, Extracted FileName, Map Name, Test/Production, Direction, TradingPartner Name, Generate Acknowledgement?, Element Separator, Release Character, Segment Terminator, SubElement Separator, Send TO (Outbound Extraction Directory), Acceptor Lookup Alias, Application Sender ID, and Application Receiver ID.

8. The service of claim 1, wherein said providing of a template comprises providing a template suitable for use with a spreadsheet application operable to store the values as a delimited text file.

9. The service of claim 8, wherein the delimited text file is a comma separated file.

10. A computer program product comprising computer executable instructions, stored on a computer readable medium, for provisioning relationships in an electronic data interchange (EDI) environment, the instructions including instructions for:
extracting a set of document exchange parameter values from a stored file;
automatically generating an EDI compliant document envelope based on the values; and
storing the document envelope to a specified directory.

11. The computer program product of claim 10, wherein automatically generating the EDI compliant document envelope includes invoking an envelope creation style sheet.

12. The computer program product of claim 10, further comprising instructions for:
populating a template of a spreadsheet application with the document exchange values.

13. The computer program product of claim 12, wherein the instructions for populating comprise instructions for enabling a user to manually enter the document exchange parameter values.

14. The computer program product of claim 10, wherein the instructions for populating comprise instructions for automatically populating the template based on an envelope definition generated by a legacy EDI application.

15. The computer program product of claim 10, wherein the EDI compliant envelope is selected from an Accredited Standards Committee (ASC) X12 compliant envelope and an EDIFACT compliant envelope.

16. The computer program product of claim 10, wherein the document exchange parameters include parameters selected from the list of parameters consisting of: EDI Standard, Interchange Sender Qualifier, Interchange SenderID, Interchange Receiver Qualifier, Interchange ReceiverID, Group SenderID, Group ReceiverID, Interchange Version, Group Version, Transaction Set/Message Type, Extraction Directory, Extracted FileName, Map Name, Test/Production, Direction, TradingPartner Name, Generate Acknowledgement?, Element Separator, Release Character, Segment Terminator, SubElement Separator, Send TO (Outbound Extraction Directory), Acceptor Lookup Alias, Application Sender ID, and Application Receiver ID.

17. The computer program product of claim 10, wherein said providing of a template comprises providing a template suitable for use with a spreadsheet application operable to store the values as a delimited text file.

18. The computer program product of claim 17, wherein the delimited text file is a comma separated file.

19. A data processing system, comprising:
a processor; and
computer readable storage accessible to the processor and including computer executable instructions, the instructions comprising instructions for automatically generating an extensible markup language (XML) file suitable for defining an electronic data interchange (EDI) document envelope from a delimited text file containing values for a set of N or fewer envelope creation parameters, wherein N is 25.

20. The system of claim 19, wherein the instructions further comprise instructions for automatically populating the delimited text file with the values based on an EDI document envelope of a legacy EDI application.
